(19) United States
(12) Patent Application Publication
(10) Pub. No.: US 2013/0325565 A1
(43) Pub. Date: Dec. 5, 2013

(54) METHOD FOR LOCATING A PARKING SPACE THAT IS SUITABLE FOR PARKING IN THE VICINITY OF THE VEHICLE, AND A VEHICLE ASSISTANCE SYSTEM THAT IS SUITABLE FOR THIS PURPOSE

(71) Applicant: Gisela Toussaint, Karlsruhe (DE)

(72) Inventor: Gisela Toussaint, Karlsruhe (DE)

(21) Appl. No.: 13/695,923

(22) PCT Filed: May 5, 2011
(86) PCT No.: PCT/EP2011/002242

§ 371 Date: Aug. 15, 2013

(30) Foreign Application Priority Data
May 5, 2010 (DE) 10 2010 019 464.6
May 5, 2010 (DE) 10 2010 019 465.4
May 5, 2010 (DE) 10 2010 019 466.2

(51) Int. Cl. G08G 1/14

(52) U.S. Cl. CPC G08G 1/143
USPC 705/13; 340/932.2

(57) ABSTRACT

A process and a vehicle assistance system for determining parkable free parking area close to motor vehicles is proposed, with the use of a central computing center, in which the geographic coordinates of parking area are determined, and of a plurality of user terminals, which are arranged in a decentralized manner in vehicles and which communicate with the computing center and which are each functionally connected with at least one location determination module. A parking location signal of the corresponding vehicle is transmitted by means of a corresponding user terminal to the computing center when the vehicle has been parked, after which the parking location signal is compared in the computing center with the coordinates of the parking area, which are contained there, in order to make a distinction in the parking area between parkable free parking area and nonparked, occupied parking area, so that the free parking area or the occupied parking area is contained. Inquiries about free parking area are transmitted to the computing center automatically or as needed by means of a corresponding user terminal, and the inquiries comprise the current position of the vehicle. Furthermore, information on parkable free parking area close to the motor vehicle, which information depends on the current position of the vehicle, is transmitted from the computing center to the user terminal making the inquiry.

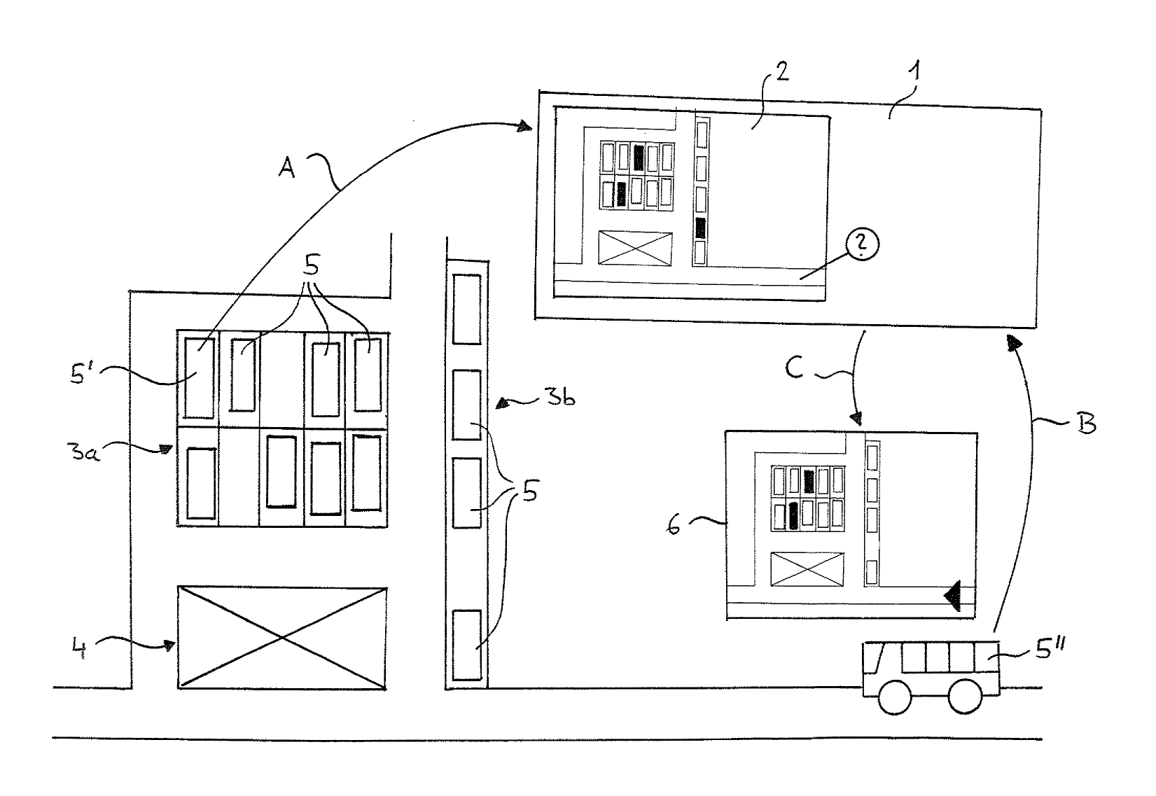

### CROSS REFERENCE TO RELATED APPLICATIONS

This application is a United States National Phase application of International Application PCT/EP2011/002242 and claims the benefit of priority under 35 U.S.C. §119 of German patent application DE 10 2010 019 466.2 of May 5, 2010, German patent application DE 10 2010 019 465.4 of May 5, 2010 and German patent application DE 10 2010 019 464.6 of May 5, 2010, the entire contents of which are incorporated herein by reference.

### FIELD OF THE INVENTION

The present invention pertains to a process for determining free parkable parking area close to motor vehicles with the use of

at least one central computing center, in which the geographic coordinates of the parkable parking area are contained; and

a plurality of user terminals, which are arranged in a decentralized manner in vehicles and which communicate with the computing center and are each functionally connected with at least one location determination module, wherein at least one parking location signal of the corresponding vehicle is transmitted by means of a corresponding user terminal to the computing center when the vehicle has been parked, after which the parking location signal is compared in the computing center with the coordinates of the parking area, which were contained there at the parking location in order to make it possible to make a distinction in the parking area between parkable, free parking area and nonparked, occupied parking area, so that the free parking area and/or the occupied parking area is detected, wherein inquiries about free parking area are transmitted to the computing center automatically or as needed by means of a corresponding user terminal of a corresponding vehicle, wherein the inquires comprise the current position of the vehicle, and wherein information on parkable free parking area close to vehicles, which information depends on the current position of this motor vehicle, is transmitted from the computing center to the user terminal making the inquiry.

The present invention pertains, furthermore, to a vehicle assistance system suitable especially for carrying out such a process for determining free parkable parking area close to a vehicle, especially for carrying out the process above, comprising:

(a) at least one central computing center with a transmitting unit, a receiving unit and a data processing unit as well as with a memory unit, in which a data bank is stored, in which the geographic coordinates of the parking area are stored; and
(b) a plurality of user terminals arranged in a decentralized manner in vehicles with a transmitter and with a receiver, which communicate with the receiving unit and with the transmitting unit of the computing center, with a location determination module, especially in the form of a GPS receiver, which is designed for detecting the geographic coordinates of the corresponding vehicle at least in a parked position thereof, and with a parked state detection module, which recognizes when the corresponding vehicle has been parked or removed from the parking area;
wherein:

the transmitter of a corresponding user terminal is designed to transmit at least one parking location signal and/or at least one parking-exit location signal to the receiving unit of the computing center when the corresponding vehicle has been parked or has exited, as well for sending an inquiry about free parking area automatically or as needed to the receiving unit of the computing center, wherein the inquiries comprise the current position of the vehicle, and

the receiver of a corresponding user terminal is designed to receive information on parkable free parking area close to the motor vehicle, which information depends on the current position of the corresponding motor vehicle, from the transmitting unit of the computing center; and

the data processing unit of the computing center is designed, for comparing a parking position signal received from a corresponding user terminal with the geographic coordinates of the parking area, which coordinates are stored in the data bank, in such a way as to make a distinction between parkable, free parking area and parked, occupied parking area and thus to detect the free parking area and/or the occupied parking area, and

the transmitting unit of the computing center is designed to transmit information on parkable free parking area close to the motor vehicle, which information depends on the current position of a particular motor vehicle, to the receiver of the user terminal of the corresponding vehicle, which said user terminal is making the inquiry.

Finally, the present invention pertains to a user terminal of such a vehicle assistance system.

### BACKGROUND OF THE INVENTION

It is known in motor vehicles that they may be equipped with location determination modules, especially in the form of navigation systems, which are capable of communicating with managing units or computing centers in a satellite-supported manner via GPS (“Global Positioning System”) in order to determine, on the one hand, the exact geographic location of the device or of the motor vehicle itself. Various functionalities, namely, the communication only between the vehicle and GPS, on the one hand, but, on the other hand, also the transmission of the current location of the motor vehicle to third parties, can be achieved by means of the navigation system and GPS; the latter is done, for example, when the vehicle is a truck, whose locations shall be transmitted to a carrier.

To increase the accuracy of the position data of the motor vehicle, wireless communication networks available, such as WLAN networks or other systems, which are suitable for providing geographic location coordinates with the highest accuracy possible, may be additionally used, currently mainly in cities. Furthermore, the coupled use (XPS) of WLAN systems, on the one hand, and GPS, on the other hand, is known and may be used, for example, to determine the geographic location coordinates of motor vehicles to the accuracy of cm or even mm. Mobile communication devices, such as telephones or computers with Internet access, are used as additional communication devices for receiving and for transmitting information to the motor vehicle or from the motor vehicle. Moreover, it is known that it is possible to use a relatively novel data transmission system, which is based on Long Term Evolution Technology (LTE or LTE-Advance), and surpasses the data transmission rates of common systems usually based on UMTS (Universal Mobile Telecommunications System).

Despite the plurality of such communication devices, which have already been widely used and which are also available to the driver of a motor vehicle or even to managers of motor vehicles, there are still unsolved information tasks in motor vehicle traffic and generally in the area of the transportation of people and goods. Such defects of information pertain, for example, to the communication-supporting finding of parking area or spaces for various motor vehicles, which are also actually available for a particular vehicle, i.e., are free and thus parkable and are especially located as close as possible to a vehicle looking for a space.

DE 198 56 478 C1 describes a process for the automatic detection of information concerning occupied parking area in a traffic system, wherein parking area information, which represents both a parking phase of the vehicle and the location of vehicle, is sent from a vehicle-mounted user terminal to a computing center, after which information is generated by the center, and this information pertains to the still free parking area, and after which information on the parkable, still free parking area is transmitted by the computing center to the vehicle-mounted user terminal.

### SUMMARY OF THE INVENTION

The basic object of the present invention is to further improve a process and especially a vehicle assistance system suitable for carrying out same for determining parkable free parking area close to the vehicle, which process and vehicle assistance system are of the type described in the introduction, such that the driver of a motor vehicle will become able to find a suitable parking area with the greatest possible probability within the shortest possible time and by driving the shortest possible distance.

From a technological point of view, this object is accomplished with a process of the type mentioned in the introduction, which is characterized by the following steps:
Classification of the parking area contained in the computing center with respect to a plurality of parking area categories;
Transmission of at least one additional piece of information by means of a corresponding user terminal to the computing center at the time of the automatic or as-needed inquiry about free parking area, wherein the at least one additional piece of information comprises at least one vehicle-specific piece of information from the group of the type of vehicle, vehicle size and vehicle model and/or at least one user-specific piece of information;
comparing of the at least one additional piece of information transmitted by means of a corresponding user terminal with the classified parking area categories in the computing center in order to make a distinction between parking area categories that correspond to the additional information, and parking area categories that do not correspond to the additional information, so that the free parking area, whose parking area category corresponds and/or does not correspond to the additional information, is determined; and
transmission of information on the parkable free parking area close to the motor vehicle from the computing center to the user terminal making the inquiry, whose parking area category corresponds to the at least one piece of additionally transmitted information, wherein the parkable free parking area close to the motor vehicle, which parking area belongs to this parking area category, is displayed by means of the user terminal.

With respect to the device, the present invention makes, further, provisions for accomplishing this object in a vehicle assistance system of the type mentioned in the introduction,
for the parking area being stored in the data bank of the computing center to be classified with respect to a plurality of parking area categories;
for at least one piece of additional information to be stored in a corresponding user terminal, wherein the at least one piece of additional information comprises at least one piece of vehicle-specific information from the group of the type of vehicle, vehicle size and vehicle model and/or at least one piece of user-specific information;
for the transmitter of a particular user terminal to be designed to transmit the additional information to the receiving unit of the computing center at least at the time of the automatic or as-needed inquiry about free parking area;
for the data processing unit of the computing center to be designed to compare the at least one piece of additional information transmitted by means of a corresponding user terminal with the parking area categories classified in the data bank in order to make a distinction between parking area categories that correspond to the additional information and parking area categories that do not correspond to the additional information and thus to determine the free parking area, whose parking area category corresponds and/or does not correspond to the additional information;
for the transmitting unit of the computing center to be designed to transmit information on the parkable free parking area close to the vehicle, whose parking area category corresponds to the at least one piece of additionally transmitted information to the receiver of the user terminal making the inquiry; and
for the corresponding user terminal to have a display means, which is designed for the especially graphic display of the parkable free parking area close to the motor vehicle, which belongs to this parking area category.

Finally, the present invention also pertains to a user terminal of a vehicle assistance system for determining parkable free parking area close to the motor vehicle, which vehicle assistance system is of the above-mentioned type, and which is preferably implemented in a navigation device of the vehicle or is integrated in same.

A “computing center” in the sense of the present invention is defined as a central managing unit, which is equipped especially with transmitting and receiving units, data processing unit, such as computers or the like, as well as with memory units. A data bank, in which the geographic coordinates of the parking area are stored, is preferably stored in said memory unit. The geographic coordinates may, in turn, be drawn, for example, cartographically or may, e.g., also be indicated by simply stating the longitudes and latitudes.

As will also be explained in more detail below, a “parking area” may designate, on the one hand, individual parking spaces, but, on the other hand, also groups of parking spaces.

The parking area contained in the data bank of the computing center is assigned or classified according to the present invention into different parking area categories or dedications, and these parking area categories or dedications may be especially vehicle-specific and/or user-specific. For example, a value or a function, which value or function stands for a certain parking area category, may be assigned, for example, in the data bank to each parking space or each group of parking spaces. Corresponding parking area dedications or categories are stored in the vehicle-mounted user terminals in the form of the additional information, so that a driver is able to send an inquiry to the computing center by means of a vehicle-mounted user terminal, as needed or in an automated form, that he is looking for free parking area. Since not only the current position of the vehicle but also the at least one piece of additional information, be it vehicle-specific and/or user-specific information, are also sent to the computing center together with this inquiry, it is possible to determine in the computing center which of the available, free parking areas are also specially suitable for the vehicle making the inquiry by the additional information transmitted being compared with the parking area categories stored there. Consequently, information on exactly the same parkable, free parking area close to the motor vehicle, whose parking area category corresponds to the individual, additionally transmitted information of the driver, can be sent to the driver as a reply to his inquiry, and this parkable, free parking area of this parking area category, which parking area is close to the motor vehicle, is displayed by means of his user terminal.

The reliability with which a free parking area is found is consequently considerably increased compared with the state of the art according to DE 198 56 478 C1 cited above because distinction can be made between a parking area for the particular vehicle or for the particular user or driver, and it is possible in this manner to determine not only the free parking areas, but also the individually suitable and free parking areas, which the person looking for a parking area can then specifically drive to, which is associated with a reduction of the time needed and with reduced use of energy.

The process according to the present invention can be carried out in a territorially limited area, such as within a parking garage, a public or commercial parking area with a plurality of parking spaces or the like, or even within one or more city centers or within individual states or a plurality of states.

Provisions may be made in an advantageous embodiment for at least one parking-exit location signal of the corresponding vehicle to be transmitted to the computing center by means of a corresponding user terminal when the vehicle has exited the parking area, after which the corresponding parking area, previously identified as occupied, is detected as a free parking area in the computing center. Consequently, it is possible to determine in the computing center not only when a previously free parking area has become occupied (a parking location signal has been received), but also when a previously occupied parking area has become free (a parking-exit location signal has been received), so that the process according to the present invention can be applied to any desired, freely accessible parking area, and not only a parking area that primarily becomes free at certain times anyway (e.g., company parking areas, parking garages with fixed closing times, etc.).

Provisions may be made in another advantageous embodiment for the geographic coordinates of the parking area to be modified in the computing center when previously available parking area is permanently or temporarily unparkable and/or when parking area not yet contained is additionally available, as it may happen, e.g., in case of construction sites, moving operations, etc., on the one hand, and, on the other hand, in case new parking area is created. The data bank of the computing center is thus constantly updated, and a corresponding parking area category or dedication is, in turn, assigned especially to any newly added parking area.

Several criteria are available for the classification of the parking area into the different parking area categories. Thus, provisions may be made according to a preferred embodiment for the classification of the parking area contained in the computing center with respect to a plurality of parking area categories to comprise at least one vehicle-specific parking area category from the group comprising suitability of the parking area category in question for a certain type of vehicle, suitability of the parking area category in question for a certain vehicle size, suitability of the parking area category in question for a certain vehicle model, and/or at least one user-specific parking area category based on an authorization of a certain vehicle user to use the parking area category in question.

As far as advantageous vehicle-specific parking area categories are concerned, these may be preferably selected from the group comprising
type of vehicle or determination of the parking area in question for a certain type of vehicle, especially from the group of passenger cars, trucks, buses, motorcycles and sidecar motorcycles; and/or
vehicle size or parking area size, especially on the basis of the corner coordinates of the parking area detected.
   It shall be pointed in respect to the advantageous determination of the size of the parking area that, e.g., all four corner coordinates (especially of the parking area, on the one hand, in the computing center, and, on the other hand, of the vehicle in the corresponding user terminal), or, for example, also only three corner coordinates, such as the opposite corner coordinates, as well as a further corner coordinate are determined, which is usually sufficient to define the position of an essentially rectangular body.

As far as advantageous vehicle-specific parking area categories provided alternatively and preferably additionally are concerned, these may preferably comprise from the groups of
user groups, such as emergency vehicles, especially of fire companies, police and/or rescue vehicles, taxis, local residents, people with disabilities, women and/or men; and/or
individual users, such as private users of individual parking areas.

As was mentioned already, at least some of these parking area categories or dedications are assigned, on the one hand, in the data bank of the computing center to the parking area contained there, and, on the other hand, they are stored in a vehicle- or user-specific manner, in the form of the additional information, in a corresponding user terminal in order to make it possible to make the suitable selection in case of a corresponding inquiry about a suitable, free parking area.

Provisions may be made in an advantageous variant for the at least one piece of additional information, which comprises at least one piece of vehicle-specific information from the group comprising the type of vehicle, vehicle size and vehicle model and/or at least one piece of user-specific information, to be transmitted from the corresponding user terminal automatically, especially together with the parking location signal, to the computing center when the corresponding vehicle has been parked, according to which it is determined whether the vehicle has been parked in the parking area having a corresponding parking area category or not. If this additional, vehicle- or user-specific information is transmitted from the corresponding user terminal to the computing center not only at the time of an inquiry about free parking area, but also automatically, when the parking location signal is generated, it is consequently possible to determine whether the corresponding vehicle has been parked, e.g., in an unauthorized manner, in a parking area not intended for it, for example, a private passenger car in a parking area intended for an emergency vehicle, bus, people with disabilities or the like.

Provisions may, moreover, be made in this connection in an advantageous variant for the geographic coordinates of unparkable area to be, furthermore, contained in the computing center, and a warning signal, which is displayed by means of the user terminal, is sent to the corresponding user terminal in the case in which a parking location signal is sent to the computing center by means of a corresponding user terminal when this vehicle has been parked and it is recognized by comparing this parking location signal with the geographic coordinates of unparkable area, which coordinates are contained in the computing center, that the location of the parking area of the motor vehicle is located fully or partly in an unparkable area and/or fully or partly in a parking area of a parking area category not corresponding to the vehicle-specific and/or user-specific information transmitted from the user terminal of the vehicle.

Regardless of whether the vehicle is parked within a parking area that is not suitable for the vehicle in question or within an unparkable area, which is not suitable for vehicles of any type, size, model or user, it is possible in this manner to display to the driver of a vehicle parked in an unacceptable manner that he or she is not parking in conformity with the rules corresponding to the corresponding parking area category or dedication.

Moreover, it is possible that, furthermore, especially with a time delay after transmitting the warning signal to the corresponding user terminal, another signal is sent to another receiver, especially a police or a security service. This additional signal may, of course, also contain further information, e.g., if the parking area is a parking area in which parking is, in principle, possible but is not being used for parking according to the rules by the corresponding vehicle or even groups of vehicles, the corresponding parking area category (e.g., “Entrance,” “Fire Protection Area,” “No stopping,” etc.). Consequently, “parking according to the rules” may comprise in this connection, on the one hand, parking regulations, as they arise from the Uniform Traffic Code, and, on the other hand, also rules that arise from private law, for example, rules that have been set up by the owner of a private parking lot. Temporary rules may also be included here, for example, the blocking of a parking area because of temporary activities.

According to another advantageous variant, provisions may be made for the classification of the parking area contained in the computing center with respect to a plurality of parking area categories to also comprise, furthermore, a distinction between parking area subject to a fee and parking area not subject to a fee, and the information on parkable free parking area close to the vehicle, which information is transmitted from the computing center to a user terminal making an inquiry, comprises additional information on parking area subject to a fee as well as possibly on the parking fee to be paid, which is additionally displayed by means of the user terminal. Consequently, another parking area category (“not subject to fee”/“subject to fee,” possibly subclassified according to the amount of the fee) may be assigned to the parking area contained in the data bank of the computing center, and—here usually independently from the additional information also transmitted with an inquiry of a corresponding user terminal—this additional information may be transmitted together with the information on the parkable free parking area close to the motor vehicle to the user terminal, e.g., such that the parking areas that are subject to a fee are characterized within the parking area found overall to be suitable.

Moreover, provisions may be made in this case for carrying out a payment method for paying the parking fee by means of the user terminal or a mobile wireless device coupled herewith, for example, while performing a fee debiting operation, which payment method can especially be performed automatically, when parking the vehicle within a parking area that is subject to a fee and/or when removing the vehicle from a parking area that is subject to a fee. Such a payment method may be triggered, e.g., by sending/receiving a parking location signal and/or parking-exit location signal if this location agrees with the geographic coordinates of a parking area that is subject to a fee.

In respect to the definition of “close to the vehicle,” provisions may be made, for example, for a surrounding area close to a vehicle making an inquiry by means of a user terminal to be defined in the computing center by setting an area with a preset or selectable radius, e.g., 50 m, 100 m, 200 mm, etc., around the current position of the vehicle. Such an area may advantageously be freely selectable by means of the user terminal, which may have for this a corresponding input means, a voice or manual input means, as it is sufficiently known.

As was suggested already, the parking area contained in the computing center on the basis of geographic coordinates may comprise the geographic coordinates of individual parking areas, for example, locally marked parking area. Moreover, the parking area contained in the computing center on the basis of geographic coordinates may comprise the geographic coordinates of group parking areas, for example, of a plurality of unmarked parking areas located at the curbside, in which case especially the parking location signals (which are received from corresponding user terminals in the computing center) of corresponding vehicles, which have been parked in such group parking areas, are used to determine the distance of these vehicles from end coordinates of the group parking areas and/or the distance between two vehicles being parked there and to determine in this manner the geographic coordinates of individual parking areas available within the group parking area, where said geographic coordinates depend on the parked position of these vehicles. The detection of such a parking area comprising group parking areas in the data bank of the computing center may, of course, contain, depending on the geometry, any desired geographic coordinates, such as the corner coordinates of the parking area groups in case of more or less rectangular group parking areas or additionally, e.g., in case of curved group parking areas arranged at the curbs of curves in the street, a plurality of intermediate coordinates, and, of course, it is possible to use both Cartesian and circular coordinates.

The transmission of the parking and parking-exit location signals, of the inquiries on free parking area as well as of the information of parkable parking area close to the vehicle may be preferably performed directly or indirectly, for example, via the Internet, by means of a wireless radio connection, where the radio connection is established via a radio interface of the user terminal or via a mobile wireless device communicating herewith, which is coupled with the user terminal in a wireless manner, especially via a short-range radio interface, or in a wired manner, wherein the radio connection supports especially a mobile wireless standard with increased download rate, preferably LTE (Long Term Evolution Technology) or LTE-Advance. The transmission may consequently take place directly via radio, directly such as from telephone to telephone or via mobile wireless device on the Internet to the data processing unit of the user terminal, and so-called cloud computing is possible as well.

Provisions may be made in an advantageous embodiment for the information on parkable free parking area of the corresponding parking area category close to the motor vehicle to be transmitted from the computing center in the form of markings, which are displayed on a graphic navigation card of the user terminals, said marking being especially an optical highlighting possibly distinguishing parking area subject to a fee from parking area not subject to a fee, such as a permanent or temporary change in color or a light signal. Furthermore, provisions may be made for transmitting, alternatively or in addition to the information on parkable free parking area of the corresponding parking area category close to the motor vehicle, information on unparkable space and/or on parkable not already occupied parking area from the computing center in the form of markings which are likewise displayed on the graphic navigation card of the user terminal, said marking being especially an optical highlighting possibly distinguishing parking area subject to a fee from parking area not subject to a fee, such as a permanent or temporary change in color or a light signal.

The parking location signal of the corresponding vehicle, which is sent by means of a corresponding user terminal to the computing center, preferably comprises a plurality of geographic coordinates of the vehicle in the parked position, especially the four—or, e.g., even only three—corner coordinates of the vehicle, so that the important information on the size of the parked vehicle is transmitted to the computing center, and it is possible, for example, to check for agreement with the parking area category being stored, on the one hand, and, on the other hand, to possibly check the parked position in relation to intended or unintended parked positions.

The determination of the geographic coordinates of a vehicle in question in the parked position is preferably performed by means of the location determination module, especially in the form of a GPS receiver, of the user terminal, wherein the coordinates of the vehicle in the parked position can be transmitted to the computing center from the corresponding user terminal especially via wireless local networks (WLAN).

Furthermore, provisions are made in an advantageous embodiment for the start and the end of a parking operation of a vehicle in question to be detected by means of the corresponding user terminal and for the parking location signal and the parking-exit location signal to be transmitted by means of the user terminal automatically to the computing center, i.e., the transmission of the parking and parking-exit location signals preferably takes place automatically.

Provisions may be made in this connection, in particular, for the start and the end of a parking operation to be detected as a consequence of

shutting off or starting the engine of the corresponding vehicle; and/or

activating or deactivating the hand brake of the corresponding vehicle; and/or

engaging or disengaging the gear shift lever of the vehicle in question with automatic transmission into or out of a parking position.

The transmission of the parking or parking-exit location signal can, of course, be triggered only if one or more of the above-mentioned triggering conditions are satisfied simultaneously. Furthermore, the transmission of the parking or parking-exit location signal can, in particular, also be compared, of course, in the computing center with the classified parking area categories stored there to determine whether the location transmitted is a potential parking area at all or—especially if the geographic coordinates of unparkable space are also stored in the data bank of the computing center and these are preferably classified as well, e.g., among other things, into a “roadway” category, etc.—whether the parking area is explicitly unparkable space, in which temporary stopping of vehicles is to be expected, but a parking/parking-exit signal can then also be ignored.

Furthermore, provisions may be made for at least the parking and parking-exit location signals to be coded during their transmission by means of the user terminal for the purpose of anonymization in order to comply with possible requirements imposed on data protection. However, it is possible in this connection that the parking/parking-exit location signals are decoded as needed, especially for the purpose of criminal prosecution, for example, in case of theft of a vehicle or infringement of the regulations.

Furthermore, it is advantageous if the process according to the present invention is carried out in real time, especially with the parkable, free parking area being continuously updated in the computing center on the basis of the parking and parking-exit location signals transmitted from the user terminals and sent upon an inquiry from a user terminal in the updated form to that user terminal. In addition, continuous updating on the display means of the user terminal may, of course, be advantageous.

The present invention will be explained in more detail below on the basis of drawings, which show exemplary embodiments only. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

The only FIGURE is a schematic view to illustrate an exemplary embodiment of the present invention.

### DESCRIPTION OF THE PREFERRED EMBODIMENTS

The drawing shows in a schematic form a computing center 1 in the form of a central managing unit, which comprises, among other things, a data bank 2, which is stored in a memory unit and in which the geographic coordinates of the parking area 3a, 3b—and optionally also of unparkable area 4—are contained, for example, in the form of the corner coordinates of individual 3a or group parking areas 3b. Especially in case of curves (not shown), the latter may additionally also be detected by intermediate coordinates in order to ensure a higher territorial detection accuracy. The corresponding geographic coordinates of the parking area 3a, 3b (and optionally of unparkable area 4) may be arranged in the data bank 2, e.g., in a road map system.

The parking area 3a, 3b stored in the data bank 2 of the computing center 1 is, furthermore, classified or dedicated with respect to different parking area categories, and these parking area categories comprise at least one vehicle-specific category from the group comprising suitability of the parking area category in question for a certain type of vehicle, suitability of the parking area category in question for a certain vehicle size, suitability of the parking area category in question for a certain vehicle model and/or at least one user-specific parking area category on the basis of an authorization of a certain vehicle user for the parking area category in question. If, for example, parking area 3a represents parking areas for tour buses in this case and parking area 3b represents parking areas for buses of the scheduled bus service, parking area 3a may comprise the parking area categories “suitability for a certain vehicle size” (e.g., on the basis of the contained geometric corner coordinates), “suitability for a certain type of vehicle” (e.g., “bus”), “suitability for a certain user group” (e.g., “tour bus”) and possibly further parking area categories. This correspondingly applies to parking area 3b as well, but the user-specific parking area category “buses for scheduled service” is marked there instead of the user-specific parking area category “tour bus.” Furthermore, a plurality of further, alternative parking area categories (e.g., “passenger car,” “motorcycle,” “vehicles of people with disabilities,” etc.) and/or cumulative parking area categories (e.g., “subject to fee payment,” “not subject to fee payment”), etc., may also be used in the data bank 2 of the computing center 1 to categorize or dedicate the available parking area.

A plurality of vehicles 5 (here, e.g., tour buses and buses of the scheduled bus service), which are each equipped with a vehicle-mounted user terminal (not shown specifically), which communicates with the computing center 1 in a wireless manner, are located in the situation being shown in both parking area 3a and in parking area 3b. Each user terminal comprises a likewise vehicle-mounted location determination module communicating therewith, such as a GPS receiver, by means of which it is likewise capable of determining especially the exact geometric coordinates, e.g., corner coordinates of the corresponding vehicle 5. Moreover, at least one piece of additional information, which likewise comprises at least one piece of vehicle-specific information from the group comprising the type of vehicle, vehicle size and vehicle model and/or at least one piece of user-specific information, is stored in each user terminal.

In the situation shown schematically in the drawing, data bank 2 of computing center 1 has already noted that a plurality of vehicles 5 have already been parked in the parking area 3a, 3b detected there. The (still) free parking area is especially also detected in this manner, and this parking area is represented with black rectangles in a schematized form.

If, for example, vehicle 5′ has just reached its parked position, its user terminal transmits a parking location signal to computing center 1 (arrow A), which causes this previously free parking area within the parking area 3a to be marked as occupied in the data bank 2, which is represented by white rectangles in a schematized form. However, the user terminal of vehicle 5′ preferably transmits not only the parking location signal, but additionally also the additional information stored there, e.g., “vehicle size,” “bus,” “tour bus,” so that it can be recognized in the computing center by comparing the corresponding parking location signal, including the additional information, with the geographic coordinates (contained in computing center 1) of parkable space 3a, 3b and optionally unparkable area 4, including the corresponding parking area category whether the parking location of bus 5′ is located fully or partly in an area that is not parkable at all or in parking area of a parking area category not corresponding to the vehicle-specific and/or user-specific information transmitted from the user terminal of bus 5′. If yes, a warning can be sent from the computing center 1 to the vehicle-mounted user terminal of bus 5′. If bus 5′ again leaves its parked position, its user terminal transmits a parking-exit location signal to computing center 1, which causes this parking area, which was previously marked as occupied, to be detected as being free again in data bank 2. Data bank 2 is thus always kept up to date in real time.

If, for example, vehicle 5″, e.g., a tour bus, is now looking for a free parking area, its driver can transmit an inquiry on free parking area to the computing center 1 (arrow B) by means of the vehicle-mounted user terminal, e.g., manually by pressing a button, by means of voice input or the like. Such an inquiry comprises, on the one hand, the current location of vehicle 5″ (determined by the location determination module coupled with the user terminal), and, on the other hand, the additional information, i.e., the at least one piece of vehicle-specific information from the group comprising the type of vehicle, vehicle size and vehicle model and/or the at least one piece of user-specific information, such as, for example, the “vehicle size,” “bus,”, “tour bus” here. In addition, the user terminal may transmit to the computing center an area around the current vehicle position, e.g., “200 m,” within which the driver would like to obtain the availability of free parking area with the suitable parking area category. As was just mentioned, such an area may be able to be selected by the user terminal or may already be predefined by the user terminal or even by the computing center 1.

If the computing center 1 has received the inquiry (arrow B) from the user terminal of tour bus 5″, the parking area that is free within the area in question (e.g., 200 m) in which the tour bus 5″ is located and would thus, in principle, be available for the tour bus 5″ is determined, on the one hand, in a data processing unit located in said computing center on the basis of the geographic coordinates of the parking area 3a, 3b stored in data bank 2 as well as on the basis of the distinction between parked and unoccupied, free parking area, which distinction is likewise detected on the basis of receiving different parking and parking-exit location signals from vehicles 5, 5′. On the other hand, the additional information (here, e.g., “vehicle size,” “bus,” “tour bus”), which has also been transmitted to the computing center 1 at the time of the inquiry from the user terminal of tour bus 5″, is compared, moreover, with the classified parking area categories stored in data bank 1 in order to make a distinction between parking area categories, which correspond to this additional information, and parking area categories that do not correspond to this additional information. It can consequently be determined in this case that only the sufficiently large parking places that are suitable for buses as such can be considered for tour bus 5″ in the area of parking area 3a (agreement in all three parking area categories), whereas the sufficiently large parking areas within parking area 3b, which are suitable for buses as such but are intended for buses of the scheduled bus service, are eliminated (agreement in two of three parking area categories only). The free parking area, whose parking area category corresponds to the additional information (as well as optionally also that which does not corresponding to this information) is determined in this manner.

Finally, as is indicated by arrow C, the information on the parkable free parking area close to the motor vehicle, whose parking area category (categories) correspond(s) to the information transmitted additionally, is transmitted from computing center 1 to the user terminal of tour bus 5″ making the inquiry, after which at least the parkable free parking area of this parking area category close to the motor vehicle is displayed by means of the user terminal. This may happen on a conventional display means 6 of the user terminal, e.g., cartographically on a navigation card, as it is widely used already in conventional navigation devices.

While specific embodiments of the invention have been shown and described in detail to illustrate the application of the principles of the invention, it will be understood that the invention may be embodied otherwise without departing from such principles.

1. Process for determining parkable free parking area close to motor vehicle with the use of
at least one central computing center, in which the geographic coordinates of the parking area are contained; and
a plurality of user terminals arranged in vehicles a decentralized manner, which communicate with the computing center and which are each functionally connected with at least one location determination module;
wherein at least one parking location signal of the corresponding vehicle is transmitted by means of a corresponding user terminal to the computing center when the vehicle has been parked, after which the parking location signal is compared in the computing center with the coordinates of the parking area contained there in order to make a distinction in the parking area between parkable, free parking area and unparkable, occupied parking area, so that the free parking area and/or the occupied parking area is detected,
wherein inquiries are transmitted to the computing center automatically or as needed by means of a corresponding user terminal of a corresponding vehicle, wherein the inquiries comprise the current position of the vehicle, and
wherein information on parkable free parking area close to the motor vehicle, which information depends on the current position of said motor vehicle, is transmitted from the computing center to the user terminal making the inquiry,
characterized in that the process comprises the following steps:
Classification of the parking area contained in the computing center with respect to a plurality of parking area categories;
transmission of at least one piece of additional information by means of a corresponding user terminal to the computing center at the time of the automatic or as-needed inquiry about free parking area, wherein the at least one piece of additional information comprises at least one piece of vehicle-specific information from the group comprising the type of vehicle, vehicle size and vehicle model and/or at least one piece of user-specific information;
comparing of the at least one piece of additional information transmitted by means of a corresponding user terminal with the classified parking area categories in the computing center in order make a distinction between parking area categories that correspond to the additional information and parking area categories that do not correspond to the additional information, so that the free parking area, whose parking area category corresponds and/or does not correspond to the additional information, is determined; and
transmission of information on the parkable free parking area close to the motor vehicle from the computing center to the user terminal making the inquiry, whose parking area category corresponds to the at least one piece of additionally transmitted information, wherein the parkable free parking area of this parking area category close to the motor vehicle is displayed by means of the user terminal.

2. Process in accordance with claim 1, characterized in that at least one parking-exit location signal of the corresponding vehicle is transmitted by means of a corresponding user terminal to the computing center when the vehicle has exited the parking area, after which the corresponding parking area, previously identified as occupied, is detected in the computing center as a free parking area.

3. Process in accordance with claim 1 or 2, characterized in that the geographic coordinates of the parking area are modified in the computing center when parking area that was previously available is permanently or temporarily unparkable and/or when new, not yet contained parking area is additionally available.

4. Process in accordance with one of the claims 1 through 3, characterized in that the classification of the parking area contained in the computing center with respect to a plurality of parking area categories comprises at least one vehicle-specific parking area category from the group comprising suitability of the parking area category in question for a certain type of vehicle, suitability of the parking area category in question for a certain vehicle size, suitability of the parking area category in question for a certain vehicle model and/or at least one user-specific category on the basis of an authorization of a certain vehicle user for the parking area category in question.

5. Process in accordance with claim 4, characterized in that the vehicle-specific parking area category is selected from the group comprising
the type of vehicle or determination of the parking area in question for a certain type of vehicle, especially from the group comprising passenger car, truck, buses, motorcycles and sidecar motorcycles; and/or
vehicle size or parking area size, especially on the basis of the corner coordinates of the parking area contained.

6. Process in accordance with claim 4, characterized in that the user-specific parking area category comprises
user groups, such as emergency vehicles, especially of fire companies, police and/or rescue vehicles, taxis, local residents, people with disabilities, women and/or men; and/or
individual users, such as private users of individual parking areas.

7. Process in accordance with one of the claims 1 through 6, characterized in that the at least one piece of additional information, which comprises at least one piece of vehicle-specific information from the group comprises the type of vehicle, vehicle size and vehicle model, and/or at least one piece of user-specific information, is transmitted by the corresponding user terminal to the computing center automatically, especially together with the parking location signal, when the corresponding vehicle has been parked, after which it is determined whether the vehicle has been parked in a parking area with a corresponding parking area category or not.

8. Process in accordance with one of the claims 1 through 7, characterized in that the geographic coordinates of unparkable area are, furthermore, contained in the computing center, and in the case in which a parking location signal has been transmitted to the computing center by means of a corresponding user terminal of a corresponding vehicle when that vehicle has been parked and it is recognized by comparing this parking location signal with the geographic coordinates of unparkable area, which coordinates are contained in the computing center, that the parking location of the motor vehicle
is located fully or partly in an unparkable area and/or
is located fully or partly on a parking area of a parking area category not corresponding to the vehicle-specific and/or user-specific information transmitted from the user terminal of the vehicle,
an alarm signal is sent to the corresponding user terminal, which is displayed by means of the user terminal.

9. Process in accordance with claim 8, characterized in that, furthermore, especially with a time delay after the transmission of the warning signal to the corresponding user terminal, another signal is transmitted to another receiver, especially a police or security service.

10. Process in accordance with one of the claims 1 through 9, characterized in that the classification of the parking area contained in the computing center with respect to a plurality of parking area categories comprises, furthermore, a distinction between parking area subject to a fee and parking area not subject to a fee, wherein the information transmitted from the computing center to a vehicle user terminal making an inquiry on parkable free parking area close to the motor vehicle comprises additional information on parking area subject to a fee and optionally on the amount of the parking fees payable, which is additionally displayed by means of the user terminal.

11. Process in accordance with claim 10, characterized in that a payment method for paying the parking fees by means of the user terminal or a mobile wireless device coupled therewith, for example, by performing a fee debiting, which method can especially be performed automatically, is carried out when stopping the vehicle within a parking area that is subject to the payment of a fee and/or when removing the vehicle from a parking area that is subject to the payment of a fee.

12. Process in accordance with one of the claims 1 through 11, characterized in that an area close to and surrounding the motor vehicle making an inquiry by means of its user terminal is defined in the computing center by setting an area with a preset or selectable radius around the current position of the vehicle.

13. Process in accordance with one of the claims 1 through 12, characterized in that the parking area contained in the computing center on the basis of geographic coordinates comprises the geographic coordinates of individual parking areas, for example, locally marked parking places.

14. Process in accordance with one of the claims 1 through 13, characterized in that the parking area contained in the computing center on the basis of geographic coordinates comprises the geographic coordinates of group parking areas, for example, of a plurality of unmarked parking areas located at the curbside, wherein the parking location signals of corresponding vehicles having parked in such group parking areas, which signals are received from corresponding user terminals in the computing center, are used to determine the distance of these vehicles from end coordinates of the group parking areas and/or the distance between two respective vehicles being parked there and in this manner the geographic coordinates depending on the parked position of these vehicles from individual parking areas available within the group parking area.

15. Process in accordance with one of the claims 1 through 14, characterized in that the transmission of the parking or parking-exit location signals, of the inquiries on free parking area as well as of the information on parkable parking area close to the motor vehicle takes place directly or indirectly, for example, via the Internet, by means of a wireless radio connection, wherein the radio connection is established via a radio interface of the user terminal or via a mobile wireless device communicating herewith, which is coupled with the user terminal in a wireless manner, especially via a short-range radio interface, or in a wired manner, wherein the radio connection supports especially a mobile wireless standard with increased download rate, preferably LTE (Long Term Evolution Technology) or LTE-Advance.

16. Process in accordance with one of the claims 1 through 15, characterized in that the information on parkable free parking area of the corresponding parking area category close to the motor vehicle is transmitted from the computing center in the form of markings, which are displayed on a graphic navigation card of the user terminal, wherein the marking is especially an optical highlighting, possibly distinguishing between parking area subject to a free and parking area not subject to a fee, such as a permanent or temporary change in color or a light signal.

17. Process in accordance with claim 16, characterized in that as an alternative or in addition to the information on parkable free parking area of the corresponding parking area category close to the motor vehicle, information on unparkable area and/or on parkable but already occupied parking area is transmitted from the computing center in the form of markings, which are displayed on the graphic navigation card of the user terminals, wherein the marking is especially an optical highlighting, possibly distinguishing between parking area subject to a free and parking area not subject to a fee, such as a permanent or temporary change in color or a light signal.

18. Process in accordance with one of the claims 1 through 17, characterized in that the parking location signal of the corresponding vehicle, which is transmitted by means of a corresponding user terminal to the computing center, comprises a plurality of geographic coordinates of the vehicle in the parked position, especially the four corner coordinates of the vehicle.

19. Process in accordance with one of the claims 1 through 18, characterized in that the determination of the geographic coordinates of a particular vehicle in the parked position is carried out by means of the location determination module, especially in the form of a GPS receiver, of the user terminal, wherein the coordinates of the vehicle in the parked position are transmitted to the computing center especially via wireless local networks (WLAN).

20. Process in accordance with one of the claims 1 through 19, characterized in that the start and the end of a parking operation of a particular vehicle are detected by means of the corresponding user terminal and the parking location signal or the parking-exit location signal are transmitted by means of the user terminal automatically to the computing center.

21. Process in accordance with claim 20, characterized in that the start and the end of a parking operation are detected as a consequence of
shutting off or starting the engine of the corresponding motor vehicle; and/or
activating or deactivating the hand brake of the corresponding vehicle; and/or
engaging or disengaging the gear shift lever of the corresponding vehicle with automatic transmission in or out of a parking position.

22. Process in accordance with one of the claims 1 through 21, characterized in that at least the parking and parking-exit location signals are coded during their transmission by means of the user terminal for the purpose of anonymization.

23. Process in accordance with claim 22, characterized in that the parking and parking-exit location signals are decoded when needed, especially for the purpose of criminal prosecution, for example, in case of theft of a vehicle or an infringement of the regulations.

24. Process in accordance with one of the claims 1 through 23, characterized in that it is carried out in real time, and especially the parkable free parking area is updated continuously in the computing center on the basis of parking and parking-exit location signals transmitted from the user terminals and transmitted upon inquiry from a user terminal to said user terminal in the updated form.

25. Vehicle assistance system for determining parkable free parking area close to a motor vehicle, especially for carrying out the process in accordance with one of the above claims, comprising
(a) at least one central computing center with a transmission unit, with a receiving unit and with a data processing unit as well as with a memory unit, in which a data bank, in which the geographic coordinates of the parking area are stored, is stored; and
(b) a plurality of user terminals arranged in a decentralized manner in vehicles with a transmitter and with a receiver, which communicate with the receiving unit and with the transmitting unit of the computing center, with a location determination module, especially in the form of a GPS receiver, which is designed to detect the geographic coordinates of the corresponding vehicle at least in a parked position of said vehicle, and with a parked state detection module, which recognizes when the corresponding vehicle has been parked or has exited;
wherein
the transmitter of a particular user terminal is designed to transmit at least one parking location signal and/or at least one parking-exit location signal to the receiving unit of the computing center when the corresponding vehicle has been parked or has exited, as well as to make inquiries, automatically or as needed, about free parking area from the receiving unit of the computing center, wherein the inquiries comprise the current position of the vehicle, and
the receiver of a corresponding user terminal is designed to receive information on parkable free parking area close to the motor vehicle, which information depends on the current position of the corresponding motor vehicle, from the transmitting unit of the computing center;
and wherein
the data processing unit of the computing center is designed for comparing a parking location signal and/or parking-exit location signal received from a corresponding user terminal with the geographic coordinates of parking area stored in the data bank such as to make a distinction between parkable free parking area and parked, occupied parking area and thus to detect the free parking area and/or the occupied parking area, and
the transmission unit of the computing center is designed to transmit information on parkable free parking area, which information depends on the current position of a vehicle in question, to the receiver of the user terminal of the corresponding vehicle, which said user terminal is making the inquiry,
characterized in that
the parking area stored in the data bank of the computing center is classified with respect to a plurality of parking area categories;
at least one piece of additional information is stored in a corresponding user terminal, wherein the at least one piece of additional information comprises at least one piece of vehicle-specific information from the group comprising the type of vehicle, vehicle size and vehicle model and/or at least one piece of user-specific information;
the transmitter of a corresponding user terminal is designed to transmit the additional information to the receiving unit of the computing center at least at the time of the automatic as-needed inquiry about free parking area;
the data processing unit of the computing center is designed to compare the at least one piece of additional information transmitted by means of a corresponding user terminal with the classified parking area categories stored in the data bank in order to make a distinction between parking area categories that correspond to the additional information and parking area categories that do not correspond to the additional information and thus to determine the free parking area, whose parking area category corresponds and/or does not correspond to the additional information;
the transmitting unit of the computing center is designed to transmit information on the parkable free parking area close to the motor vehicle whose parking area category corresponds to at least one piece of additionally transmitted information to the receiver of the user terminal making the inquiry; and
the corresponding user terminal has a display means, which is designed for the especially graphic display of the parkable free parking area of that category close to the motor vehicle.

26. User terminal of a vehicle assistance system for determining parkable free parking area close to motor vehicles in accordance with claim 25.

27. User terminal in accordance with claim 26, characterized in that it is implemented in a navigation device of the vehicle.
